(19) United States
(12) Patent Application Publication
(10) Pub. No.: US 2002/0077814 A1
(43) Pub. Date: Jun. 20, 2002

(54) Voice recognition system method and apparatus

(76) Inventors: Harinath Garudadri, San Diego, CA (US); Andrew P. DeJaco, San Diego, CA (US); Chienchung Chang, Rancho Santa Fe, CA (US)

Correspondence Address: Qualcomm Incorporated, Patents Department, 5775 Morehouse Drive, San Diego, CA, 92121-1714, US

(21) Appl. No.: 09/741,457

(22) Filed: Dec. 18, 2000

(51) Int. Cl. G10L 17/00

(52) U.S. Cl. 704/246

(57) ABSTRACT

A novel and improved method and an accompanying apparatus provide for a distributed voice recognition (VR) capability in a remote device (201). Remote device (201) decides and controls what portions of the VR processing may take place at remote device (201) and what other portions may take place at a base station (202) in wireless communication with remote device (201).

### BACKGROUND

I. Field of the Invention

The disclosed embodiments relate to the field of voice recognition, and more particularly, to voice recognition in a wireless communication system.

II. Background

Voice recognition (VR) technology, generally, is known and has been used in many different devices. VR often is implemented as an interactive user interface with a device. Referring to FIG. 1, generally, the functionality of VR may be performed by two partitioned sections such as a front-end section 101 and a back-end section 102. An input 103 at front-end section 101 receives voice data. The voice data may be in a Pulse Code Modulation (PCM) format. PCM technology is generally known by one of ordinary skill. A microphone (not shown) may originally generate the voice data. The microphone through its associated hardware and software converts audible input voice information into voice data in PCM format. Front-end section 101 examines short-term spectral properties of the input voice data, and extracts certain front-end voice features, or front-end features, that are possibly recognizable by back-end section 102. Back-end section 102 receives the extracted front-end features at an input 105, a set of grammar definitions at an input 104, and acoustic models at an input 106.

Grammar input 104 provides information about a set of words and phrases in a format that may be used by back-end section 102 to create a set of hypotheses about recognition of one or more words. Acoustic models at input 106 provide information about certain acoustic models of the person speaking into the microphone. A training process normally creates the acoustic models. The user may have to speak several words or phrases for his or her acoustic models to get created. The acoustic models are used as a part of recognizing the words as spoken by the person speaking into the microphone.

Back-end section 102 in effect compares the extracted front-end features with the information received at grammar input 104 to create a list of words with an associated probability. The associated probability indicates the probability that the input voice data contains a specific word. A controller (not shown), after receiving one or more hypotheses of words, selects one of the words, most likely the word with the highest associated probability, as the word contained in the input voice data. The grammar information may include a list of commonly spoken words, such as “yes”, “no”, “off”, “on”, etc. Each word may be associated with a function in the remote device. To effectuate a wide range of VR functions, the grammar information may include a long list of words for recognizing a large vocabulary. To provide a large list of words and associated functions, and perform back-end functions for all the available words, the back-end section 102 may require a substantial amount of processing power and memory.

In a device with limited processing power and memory, such as a cellular phone, it is desirable to have a VR user interface for operation in accordance with a wide range of functions. It is to this end as well as others that there is a need for VR functionality for a wide range of user functions.

### SUMMARY

Generally stated, a method and an accompanying apparatus provides for a distributed voice recognition (VR) capability in a remote device. The remote device decides and controls what portions of the VR processing may take place at the remote device and what other portions may take place at a base station in wireless communication with the remote device. As a result, the network traffic for VR processing is alleviated, and the VR processing is performed more efficiently and more quickly.

### BRIEF DESCRIPTION OF THE DRAWINGS

The features, objects, and advantages of the disclosed embodiments will become more apparent from the detailed description set forth below when taken in conjunction with the drawings in which like reference characters identify correspondingly throughout and wherein:

FIG. 1 illustrates conventional distributed partitioning of voice recognition functionality between two partitioned sections such as a front-end section, and a back-end section; and

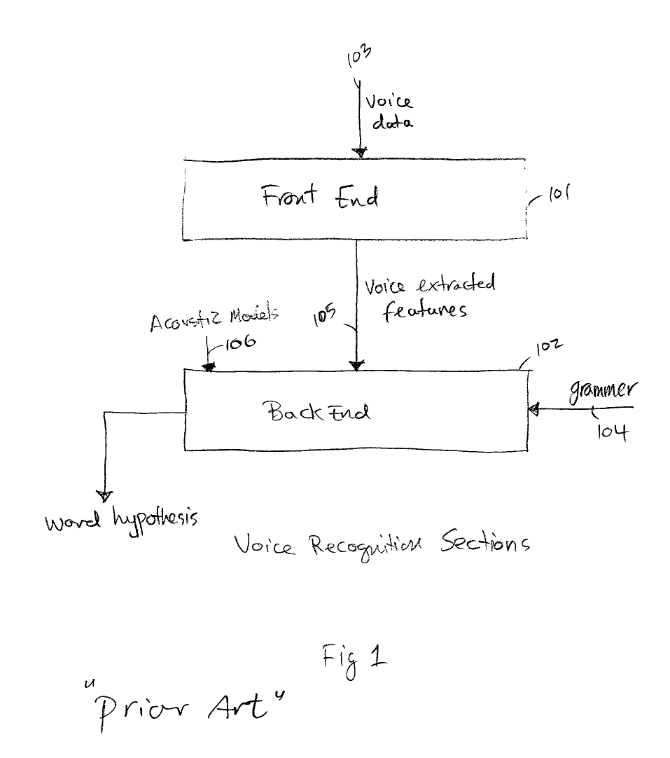

FIG. 2 depicts a block diagram of a communication system incorporating various aspects of the disclosed embodiments.

### DETAILED DESCRIPTION OF THE PREFERRED EMBODIMENT

Generally stated, a novel and improved method and an accompanying apparatus provide for a distributed voice recognition (VR) capability in a remote device. The exemplary embodiment described herein is set forth in the context of a digital communication system. While use within this context is advantageous, different embodiments of the invention may be incorporated in different environments or configurations. In general, the various systems described herein may be formed using software-controlled processors, integrated circuits, or discrete logic. The data, instructions, commands, information, signals, symbols, and chips that may be referenced throughout the application are advantageously represented by voltages, currents, electromagnetic waves, magnetic fields or particles, optical fields or particles, or a combination thereof. In addition, the blocks shown in each block diagram may represent hardware or method steps. The remote device in the communication system decides and controls what portions of the VR processing may take place at the remote device and what other portions may take place at a base station in wireless communication with the remote device. The base station may be connected to a network. The portion of the VR processing taking place at the base station may be routed to a VR server connected to the base station. The remote device may be a cellular phone, a personal digital assistant (PDA) device, or any other device capable of having a wireless communication with a base station. The remote device opens a first wireless connection for communication of content data between the remote device and the base station. The remote device may have incorporated a commonly known micro-browser for browsing the Internet to receive or transmit content data. The content data may be any data. In accordance with an embodiment, the remote device opens a second wireless connection for communication of VR data between the remote device and the base station.

A user of the remote device may be browsing the Internet using the micro-browser. When the user of the remote device is browsing the Internet to, for example, get a stock quote, and it is desirable to use VR technology, the user can press a VR button on the remote device to start a VR software or hardware engine. The second wireless connection may be opened when the VR engine is running on the remote device, or when such a condition is detected. The user then announces a stock ticker symbol by speaking the letters of the stock ticker. The microphone coupled to the remote device takes the user input voice, and converts the input into voice data. After receiving the voice data, and when the VR engine recognizes the ticker symbol either locally or remotely, the symbol is returned back to the browser application running on the remote device. The remote device enters the returned symbol as text input to the browser in an appropriate field. At this point, the user may have successfully entered a text input without actually pressing letter keys, and only via VR.

The text entry or the application may encompass a large vocabulary or a wide range of functions as described by each word. The VR functions for hands-free application may be defined by a user service logic. A user service logic application enables the user of the remote device to accomplish a task using the device. The application as a part of the user interface module may define the relationship between the spoken words and the desired functions. This logic may be executed by a processor on the remote device. Examples of large vocabulary and dialog functions for a VR user interface may include:

1) receiving stock quotes (recognizing a ticker symbol among many possible symbols);

2) performing a stock transaction, which encompasses possible vocabularies and dialog functions of sell/buy, order, price, etc;

3) obtaining weather information for many different cities, where there are many possible cities;

4) purchasing or selling items, which includes many different items such as books, clothing, electronics, etc;

5) obtaining directions to various locations and street addresses, where those are included many different ways of giving and taking directions, and differentiating among many possible common names;

6) sending spoken text to network and allowing the device to read it back to the user for affirming or reversing what is read back to the user; and

7) many other different hands-free applications.

The remote device through its microphone receives the user voice data. The user voice data may include a command to find, for example, the weather condition in a known city, such as Boston. The display on the remote device through its micro-browser may show “Stock Quotes | Weather | Restaurants | Digit Dialing | Nametag Dialing | Edit Phonebook” as the available choices. The user interface logic in accordance with the content of the web browser allows the user to speak the key word “Weather”, or the user can highlight the choice “Weather” on the display by pressing a key. The remote device may be monitoring for user voice data and keypad input for commands to determine that the user has chosen “weather.” Once the device determines that the weather has been selected, it then prompts the user on the screen by showing “Which city?” or asks “Which city?” of the user with audible tones emitted from a speaker coupled to the remote device. The user then responds by speaking or using keypad entry. If the user speaks “Boston, Mass.”, the remote device passes the user voice data to the VR processing section to interpret the input correctly as a name of a city. In return, the remote device connects the micro-browser to a weather server on the Internet. The remote device downloads the weather information onto the device, and displays the information on a screen of the device or returns the information via audible tones through the speaker of the remote device. To speak the weather condition, the remote device may use text-to-speech generation processing.

The remote device performs a VR front-end processing on the received voice data to produce extracted voice features of the received voice data. Because there are many possible vocabularies and dialog functions, the remote device may detect a need for a first VR back-end processing to take place at the base station. The first VR back-end processing at the base station may be necessary because the back-end processing for the user voice data is either outside the limited scope of the back-end processing at the remote device, or it is preferable to perform such a task at the base station. The remote device uses the second wireless connection to transmit at least a part of the extracted voice features to perform the first VR back-end processing at the base station. Moreover, the second wireless connection may be used to transmit grammar information associated with one or more functions at the remote device. The grammar information may be a part of a content document received from the network. Additionally, the grammar information can be created by a processor of the remote device based on the content information present in the content document being browsed by the user. In one example, when the browser is connected to a server for retrieving weather information, the grammar information included in the content information may be related to names of places or cities or regions of the world. Transmission of the grammar information may be necessary to assist the base station in performing the first VR back-end processing at the base station.

The grammar specifies a set of allowed words and phrases in a machine format that can be used by the VR engine. Typical grammars may include “association with a set of words”, “indicating a word excluded from a set of words”, “dates and times”, “name of cities in a geographic region”, “name of companies”, “a 10-digit phone number or a 12-digit credit card number”, etc. The base station may then perform the first VR back-end processing in accordance with the specified grammar. The base station, after performing the first VR back-end processing, transmits to the remote device, on the second connection, a result of the first VR back-end processing. The remote device receives on the second connection the result of the first VR back-end processing performed at the base station.

In one or more instances, the remote device may have capacity to perform some form of back-end processing, albeit in a limited way, which may be useful for some dialog functions. Thus, it may be necessary to perform a second VR back-end processing at the remote device, in addition to the first back-end processing, on at least another part of the extracted voice features, to complete the dialog functions as intended and allowed by the remote device. Moreover, it may be necessary to combine a result of the first and second VR back-end processings for completing VR of the voice data. The content data associated with the user demand are communicated via the first wireless connection.

As such, the second wireless connection is used exclusively for VR processing. The remote device controls what portion of the VR processing takes place at the base station by controlling what is being communicated on the second wireless connection.

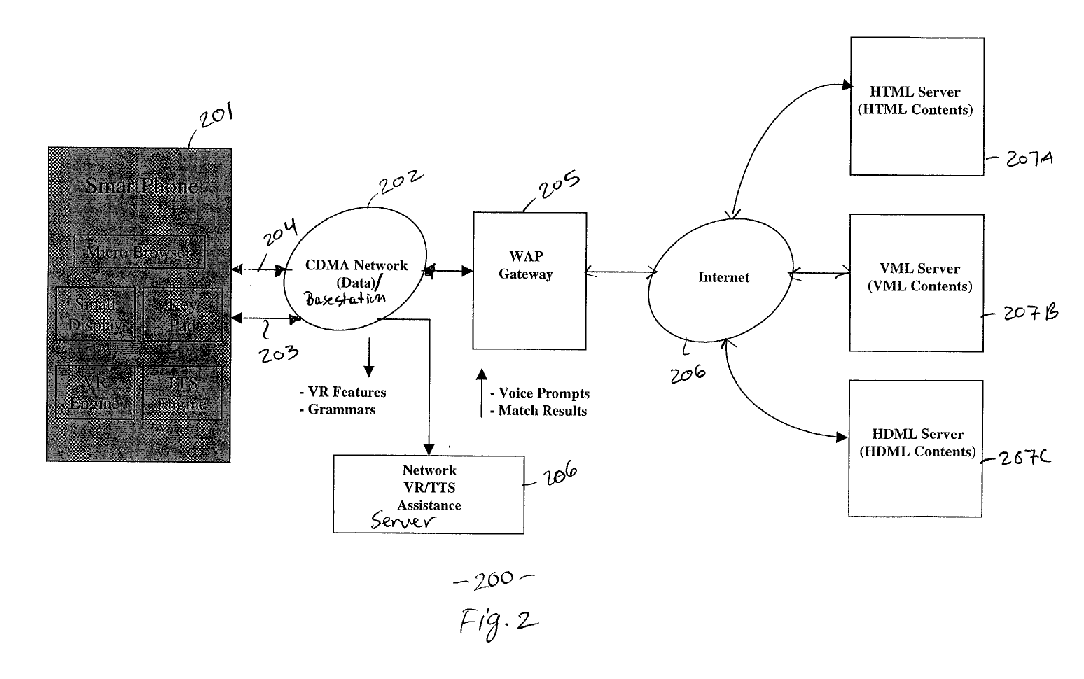

Various aspects of the disclosed embodiments may be more apparent by referring to FIG. 2. FIG. 2 depicts a block diagram of a communication system 200. Communication system 200 may include many different remote devices, even though one remote device 201 is shown. Remote device 201 may be a cellular phone, a laptop computer, a PDA, etc. The communication system 200 may also have many base stations connected in a configuration to provide communication services to a large number of remote devices. At least one of the base stations, shown as base station 202, is adapted for wireless communication with the remote devices including remote device 201. A first wireless communication link 204 is provided for exclusively communicating content data for the remote device. Base station 202 provides a second wireless communication link 203 for exclusively communicating VR data. The link 203 may be adapted to communicate data at high data rates to provide fast and accurate communication of data relating to VR processing.

A wireless access protocol gateway 205 is in communication with base station 202 for directly receiving and transmitting content data to base station 202. The gateway 205 may, in the alternative, use other protocols that accomplishes the same functions. A file or a set of files may specify the visual display, speaker audio output, allowed keypad entries and allowed spoken commands ( as a grammar). Based on the keypad entries and spoken commands, the remote device displays appropriate output and generates appropriate audio output. The content may be written in markup language commonly known as XML HTML or other variants. The content drives an application on the remote device. In wireless web services, the content may be up-loaded or down-loaded onto the device, when the user accesses a web site with the appropriate Internet address. A network commonly known as Internet 206 provides a land-based link to a number of different servers 207A-C for communicating the content data. The first wireless communication link 204 is used to communicate the content data to the remote device 201.

In addition, in accordance with an embodiment, a network VR server 206 in communication with base station 202 directly receives and transmits data exclusively related to VR processing communicated over the second wireless communication link 203. Server 206 performs the back-end VR processing as requested by remote station 201. Server 206 may be a dedicated server to perform back-end VR processing. An application program user interface (API) provides an easy mechanism to enable applications for VR running on the remote device. Allowing back-end processing at the sever 206 as controlled by remote device 201 extends the capabilities of the VR API for being accurate, and performing complex grammars, larger vocabularies, and wide dialog functions. This may be accomplished by utilizing the technology and resources on the network as described in various embodiments.

A distributed VR system has been disclosed in a U.S. Pat. No. 5,956,683, assigned to the assignee of the present invention, incorporated by reference herein. In a system with distributed VR, user commands are recognized both on the remote device and on the network, based on the complexity of the grammar. Because of the delays involved in sending the data to the network and having the VR performed on the network, users commands may be registered in the system at different times. API at the remote device may resolve or arbitrate among such entries.

In accordance with various embodiments, latency, network traffic, and the cost of deploying the VR services are reduced. Existing network VR servers do not take advantage of a VR processing control by the remote device. The existing network VR servers in accordance with various disclosed embodiments may take advantage of the information displayed on the remote device. The VR user interface application logic implemented on the remote device and on the network side as controlled by the remote device provides efficient use of VR technology, and eases the user's interface with such a device. Content generation becomes easy for a remote device that has limited keypad and text entry capability. The content generator may also provide for arbitration of multi-mode inputs occurring at different places on the device and the network, and at different times.

For example, a correction to a result of VR processing performed at VR server 206 may be performed by the remote device, and communicated quickly to advance the application of the content data. If the network, in the case of the cited example, returns “Bombay” as the selected city, the user may make correction by repeating the word “Boston.” The VR processing in the next iteration may take place on the remote device without the help of the network since a correction is being made. As such, the remote device is in control of what portions of VR processing are taking place at the VR server 206 and when is the appropriate time to use the VR server 206 for VR processing. The content data may specify the application of the correction, once such a correction has been determined. In certain situations, all the user commands may enter in a queue and each one of them can be executed sequentially or in accordance with the content application, and as decided by the remote device. In other situations, some commands (such as spoken command “STOP” or keypad entry “END”) could have higher priority over the commands in the queue. In this case, there is no need to use the network for the VR processing, therefore, the remote device performs the VR processing quickly in accordance with a defined priority. As such, the remote device controls the portions of the VR processings that are taking place at the network side. As a result, the network traffic for VR processing is alleviated, and the VR processing is performed more efficiently and more quickly.

The previous description of the preferred embodiments is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

What is claimed is:

1. A method in a communication system comprising:
opening a first wireless connection for communication of content data between a remote device and a base station;
opening a second wireless connection for exclusive communication of voice recognition data between said remote device and said base station.

2. The method as recited in claim 1 further comprising:
starting a voice recognition engine on said remote device;
triggering, based on said starting, said opening said second wireless connection for exclusive communication of voice recognition data between said remote device and said base station.

3. The method as recited in claim 1 further comprising:
receiving voice data at said remote device;
performing, at said remote device, a voice recognition front-end processing on said received voice data to produce extracted voice features of said received voice data;
detecting a need for a first voice recognition back-end processing at said base station;
transmitting on said second wireless connection at least a part of said extracted voice features to perform said first voice recognition back-end processing at said base station.

4. The method as recited in claim 1 further comprising:
transmitting on said second wireless connection grammar information associated with one or more functions at said remote device.

5. The method as recited in claim 3 further comprising:
performing said first voice recognition back-end processing at said base station;
transmitting, from said base station to said remote device, on said second connection, a result of said first voice recognition back-end processing.

6. The method as recited in claim 5 further comprising:
receiving, at said remote device, said result of said first voice recognition back-end processing performed at said base station.

7. The method as recited in claim 6 further comprising:
performing, at said remote device, a second voice recognition back-end processing on at least another part of said extracted voice features.

8. The method as recited in claim 7 further comprising:
combining a result of said first and second voice recognition back-end processings for completing voice recognition of said voice data.

9. The method as recited in claim 1 further comprising:
communicating content data via said first wireless connection.

10. The method as recited in claim 1 further comprising:
receiving, at said remote station, grammar information on said first wireless communication from said base station, wherein said grammar information relates and is based on said content data.

11. The method as recited in claim 10 further comprising:
using said grammar information received from said base station in performing voice recognition at either said remote base station, at said base station, or both.

12. In a communication system, an apparatus comprising:
at least one remote device;
at least one base station adapted for a wireless communication with said remote device, and for providing a first wireless communication link for communicating content data for said remote device, and a second wireless communication link for exclusively communicating voice recognition data for said one least remote device.

13. The apparatus of claim 12 further comprising:
a wireless access protocol gateway in communication with said base station for directly receiving and transmitting content data to said base station via said first wireless communication link.

14. The apparatus of claim 12 further comprising:
a network voice recognition server in communication with said base station for directly receiving and transmitting data exclusively related to voice recognition processing over said second wireless communication link.

15. A remote device in a communication system comprising:
means for making a first wireless connection with a base station for communication of content data;
means for making a second wireless connection with said base station for exclusive communication of voice recognition data over.

16. The remote device as recited in claim 15 further comprising:
means for display of data received via said first wireless connection; means for voice communication with said remote device;
means for analyzing said voice communication and for deciding to use said second wireless connection for exclusive communication of voice recognition data performed by said means for analyzing.
